(19) United States
(12) Patent Application Publication
(10) Pub. No.: US 2009/0315963 A1
(43) Pub. Date: Dec. 24, 2009

(54) INK JET PRINTING APPARATUS AND METHOD FOR DETERMINING DRYING CONDITION FOR PRINT IMAGE

(75) Inventors: Keiko Sakata, Kawasaki-shi (JP); Noboru Toyama, Kawasaki-shi (JP); Tsuyoshi Kanke, Yokohama-shi (JP); Noribumi Koitabashi, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/483,823

(22) Filed: Jun. 12, 2009

(30) Foreign Application Priority Data
Jun. 18, 2008 (JP) 2008-159283

(51) Int. Cl. B41J 2/01

(52) U.S. Cl. 347/102

(57) ABSTRACT

The present invention provides an ink jet printing apparatus that can substantially prevent possible variation in the color of an image on a print medium discharged from an ink jet printing apparatus. A drying condition is determined under which the color of the image varies until the color of the image becomes a target one having a color difference ΔE of at most 3 from a stable color with substantially no temporal variation. The image is dried according to the drying condition. The print medium is then discharged from the printing apparatus. This enables variation in the color of the image on the print medium discharged from the printing apparatus to be prevented from exceeding 3 in terms of color difference ΔE. As a result, a user can be prevented from perceiving variation in color.

### BACKGROUND OF THE INVENTION

1. Field of the Invention

The present invention relates to an ink jet printing apparatus that applies ink to a print medium to print an image, and a method for determining a drying condition for a print image.

2. Description of the Related Art

The quality of images printed by ink jet printing apparatuses has been improving continuously as a result of significant advancement of photographic image quality techniques relating mainly to a reduction in the size of ejected ink droplets and development of print media such as glossy paper. For a print medium (print matter) with an image printed thereon by an ink jet printing apparatus, particularly glossy paper with an image printed using aqueous die ink, the tone of the print image starts to change immediately after the end of printing and varies gradually over time. As well known, in this case, stabilizing the color of the print image requires a long time.

Controlling drying of the ink on the print medium is expected not only to stabilize the colors of the print image but also to exert various effects. Thus, various drying means and drying control means have been proposed.

For example, Japanese Patent Laid-Open No. H07-178895 (1995) discloses a method of using forced drying means based on hot or cold air or the like to dry ink on a print medium to fix the ink to the print medium early. The start and stop of the operation of the forced drying means are controlled according to the rate (black rate) of a black color in the print image.

Japanese Patent Laid-Open No. 2005-349632 describes a method involving drying means for drying and fixing ink and means for detecting the amount of ink used to print an image. The method controls a drying condition according to the amount of ink used, thus reducing the unevenness of drying of the ink and thus the unevenness of density of the image. A print rate is used to detect the amount of ink used. The print rate is determined by counting the number of driving pulses for a print head or estimated from the density of the image on a print medium read by an optical reflectance sensor.

Japanese Patent Laid-Open No. 2000-062282 describes a method of determining the density level of input image data for each pixel, then for a preset unit of image data, calculating the rate of a high density level and a low density level within the unit, and controlling the output level of a drying heater according to the calculation result. This method establishes an optimum drying condition without damaging the print medium or applying excessive energy.

Japanese Patent Laid-Open No. 2002-113853 describes a method of calculating a print density from the number of formed dots counted based on input image data, and comparing the print density with a threshold to change a print speed and a conveyance speed for a print medium, a drying condition, and the like. This method prevents the ink from being non-dried, thus achieving drying in such a way as to inhibit a subsequent lamination step from being affected.

The above-described methods using the drying means are all intended to achieve sufficient drying. Thus, it is sufficient to set a drying condition according to the amount of ink to be shot and the print density which are obtained from input image data. The color stability of the image has not been taken into account in setting the drying condition.

Thus, in the conventional ink jet printing apparatuses (particularly those using die ink), the color of an image on a print medium discharged from the printing apparatus may vary significantly. That is, the color of the image may vary while the user is holding the print image in the hand. In particular, when the image is printed using a combination of aqueous die ink and glossy paper, the color of the image starts to vary severely immediately after the end of printing.

### SUMMARY OF THE INVENTION

The present invention provides an ink jet printing apparatus and a method for determining a drying condition for a print image in which the color of an image on a print medium discharged from the ink jet printing apparatus is substantially prevented from varying.

The present invention is based on the knowledge that in a CIELAB color system (CIE 1976 (L*a*b*) color space), a color difference ΔE of larger than 3 is visually perceived. That is, in the CIELAD color system, a color difference ΔE of at most 3 is not visually perceived. This is utilized to prevent visual perception of variation in the color of an image on a print medium discharged from a printing apparatus. Thus, a color having a color difference ΔE of at most 3 from a color with substantially no temporal variation (hereinafter referred to as a “stable color”) is set to be a “target color”. Immediately after drying, the image is dried so as to forcibly change the color of the image to the target one. That is, the change in the color of the image is promoted to the degree that the difference between the color of the image and the stable color is visually unperceivable. The print medium is discharged after the process of promoting the change in color. Thus, variation in the color of the image on the discharged print medium is can be reduced to at most 3 in terms of ΔE. This enables the user to be prevented from perceiving the variation in color.

In the first aspect of the present invention, there is provided an ink jet printing apparatus for applying ink to a print medium to print an image on the print medium, the printing apparatus comprising: a setting unit configured to set a drying condition under which a color of the image varies so that the color of the image becomes a target one having a color difference ΔE of at most 3 from a color with substantially no temporal variation; a drying unit configured to dry the image according to the drying condition set by the setting unit; and a discharging unit configured to discharge the print medium with the image dried by the drying unit, from the printing apparatus.

In the second aspect of the present invention, there is provided an ink jet printing apparatus for applying ink to a print medium to print an image on the print medium, the printing apparatus comprising: a drying unit configured to dry the image printed on the print medium; a test pattern printing unit configured to apply the ink to the print medium according to data on a test pattern aIlowing a drying condition for the drying unit to be determined, to print the test pattern on the print medium; a measuring unit configured to measure a color of the test pattern printed by the test pattern printing unit; a condition determining unit configured to repeat the measurement of the test pattern by the measuring unit and the drying of the test pattern by the drying unit to determine a drying condition under which the color of the test pattern varies so that the color of the test pattern becomes a target one having a color difference ΔE of at most 3 from a color with substantially no temporal variation; and a discharging unit configured to discharge the print medium with the image dried by the drying unit according to the drying condition determined by the condition determining unit, from the printing apparatus.

In the third aspect of the present invention, there is provided an ink jet printing apparatus for applying ink to a print medium to print an image on the print medium, the printing apparatus comprising: a drying unit configured to dry the image printed on the print medium; and a discharging unit configured to discharge the print medium with the image dried by the drying unit, from the printing apparatus, wherein the drying unit dries the image so that a color of the image on the print medium not discharged by the discharging unit yet has become similar to a color with substantially no temporal variation, so as to prevent variation in the color of the image on the print medium discharged by the discharging unit from exceeding 3 in terms of color difference ΔE.

In the fourth aspect of the present invention, there is provided a drying condition determining method of determining a drying condition under which an image printed on a print medium by an ink jet printing apparatus is dried, the method comprising: a step of determining the drying condition under which the image varies until a color of the image becomes a target one having a color difference ΔE of at most 3 from a color with substantially no temporal variation.

In the fifth aspect of the present invention, there is provided a drying condition determining method of determining a drying condition under which an image printed on a print medium by an ink jet printing apparatus is dried, the method comprising: a printing step of applying ink to the print medium according to data on a test pattern allowing the drying condition to be determined, to print the test pattern on the print medium; a measuring step of measuring a color of the test pattern printed on the print medium; a drying step of drying the test pattern; and a step of repeating the measuring step and the drying step to determine a drying condition under which the color of the test pattern varies so that the color of the test pattern becomes a target one having a color difference ΔE of at most 3 from a color with substantially no temporal variation.

The present invention can reduce the variation in the color of the image on the print medium discharged from the printing apparatus to at most 3 in terms of color difference ΔE. This enables the user to be prevented from perceiving the variation in color.

Further features of the present invention will become apparent from the following description of exemplary embodiments (with reference to the attached drawings).

### BRIEF DESCRIPTION OF THE DRAWINGS

FIG. 1 is a block diagram illustrating the basic configuration of a control system for an ink jet printing apparatus that is applicable according to the present invention;

FIG. 2 is a diagram illustrating an example of a check pattern used to set a drying condition;

FIGS. 3A, 3B, and 3C are schematic side views illustrating the configuration of an ink jet printing apparatus that is applicable according to the present invention;

FIG. 4 is a flowchart illustrating an operation of setting the drying condition according to a first embodiment;

FIG. 5 is a flowchart illustrating an example of a manner of setting the drying condition according to the first embodiment; and

FIG. 6 is a schematic side view illustrating an example of the manner of setting the drying condition according to a second embodiment.

### DESCRIPTION OF THE EMBODIMENTS

Embodiments of the present invention will be described below with reference to the drawings.

### First Embodiment

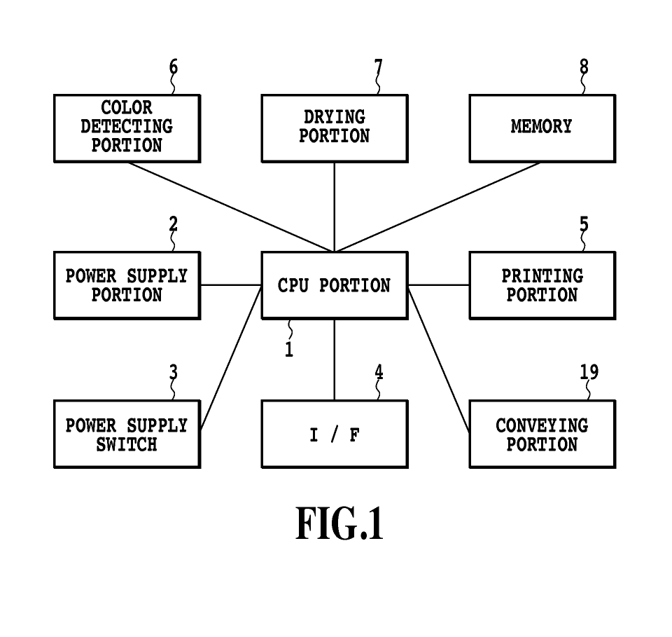

FIG. 1 is a block diagram showing an example of the basic configuration of an ink jet printing apparatus that is applicable according to the present invention.

Reference numeral 1 in FIG. 1 denotes a CPU portion that issues instructions to component portions of the ink jet printing apparatus to control the component portions. The CPU portion 1 connects to a power supply portion 2, a power supply switch 3, an interface (I/F) 4, a printing portion 5, a color detecting portion 6, a drying portion 7, a memory 8, and a conveying portion 19. The power supply portion 2 supplies power to the component portions. The power supply switch 3 controls power supply from the power supply portion 2 to each of the component portions. The I/F 4 transmits and receives signals to and from an external apparatus such as a word processing apparatus or an image producing apparatus. Based on a signal input via the I/F 4 and the CPU portion 1, for example, a signal containing image data, the printing portion 5 as printing means applies ink onto a print medium such as paper which is conveyed by the conveying portion 19, to print an image.

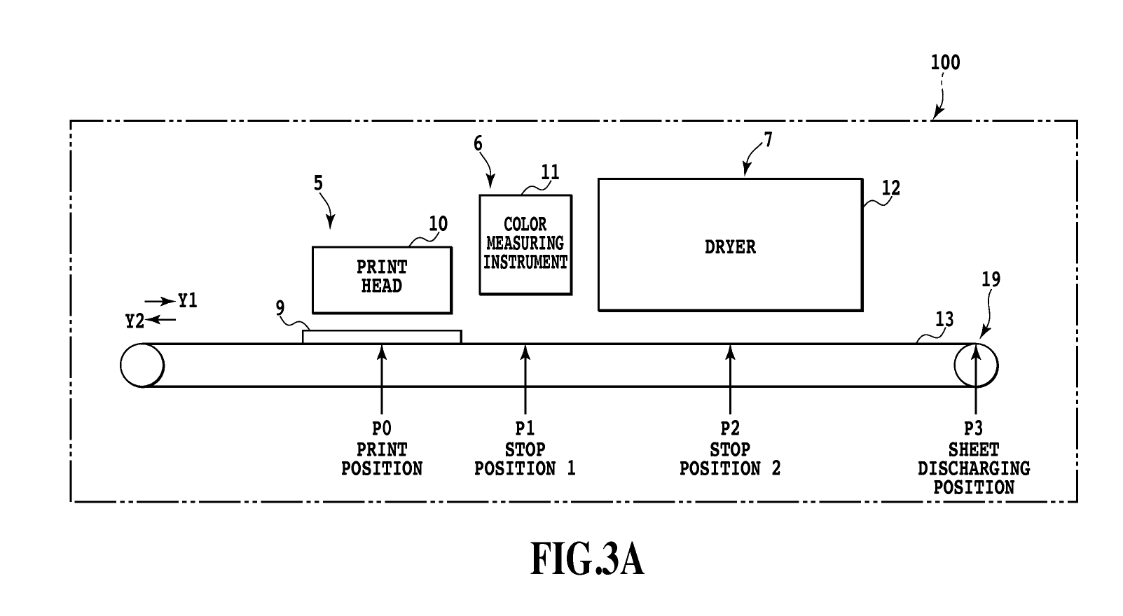

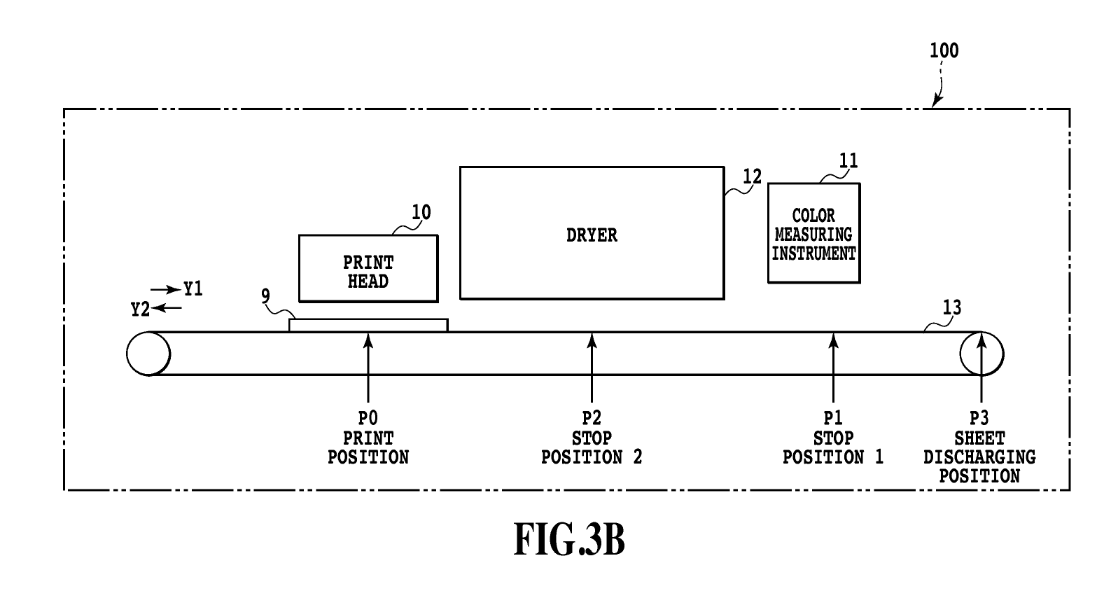

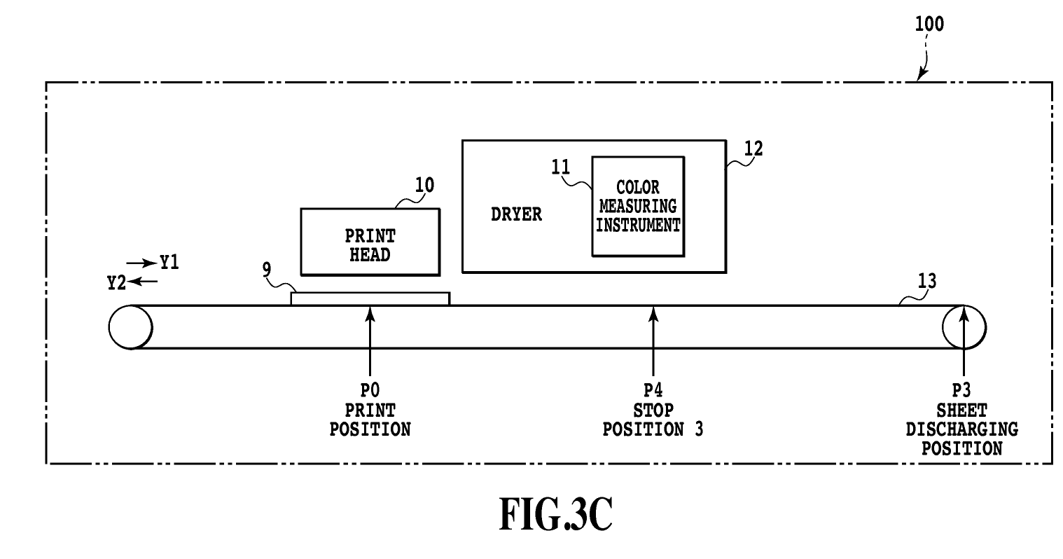

The color detecting portion 6 detects (measures) the color of a check pattern (drying condition setting test pattern) printed on the print medium by the printing portion 5. Specifically, the detecting portion 6 uses a color measuring instrument 11 (see FIG. 3A) that can measure a Lab value in a CIELAB color space (CIE 1976 (L*a*b*) color space) to detect the color of the printed check pattern. For example, an ilpro spectrometer manufactured by X-rite may be used as the color measuring instrument 11 for the Lab value. The drying portion 7 is drying means for drying ink applied onto the print medium in order to print the check pattern or an actual image (an image printed based on desired image data), as required in response to an instruction from the CPU portion 1. Drying ink promotes a temporal variation in the color of a print image (check pattern and actual image). Thus, the drying portion 7 corresponds to processing means for promoting the temporal variation in the color of the image printed on the print medium.

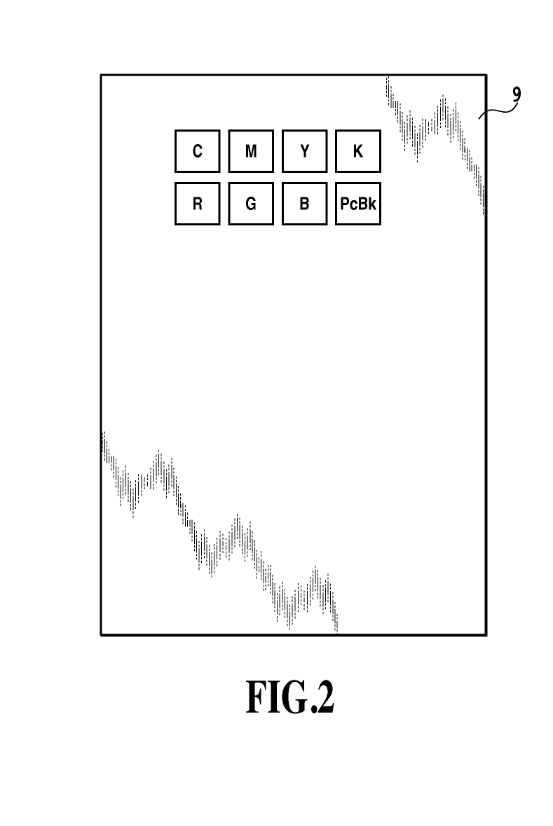

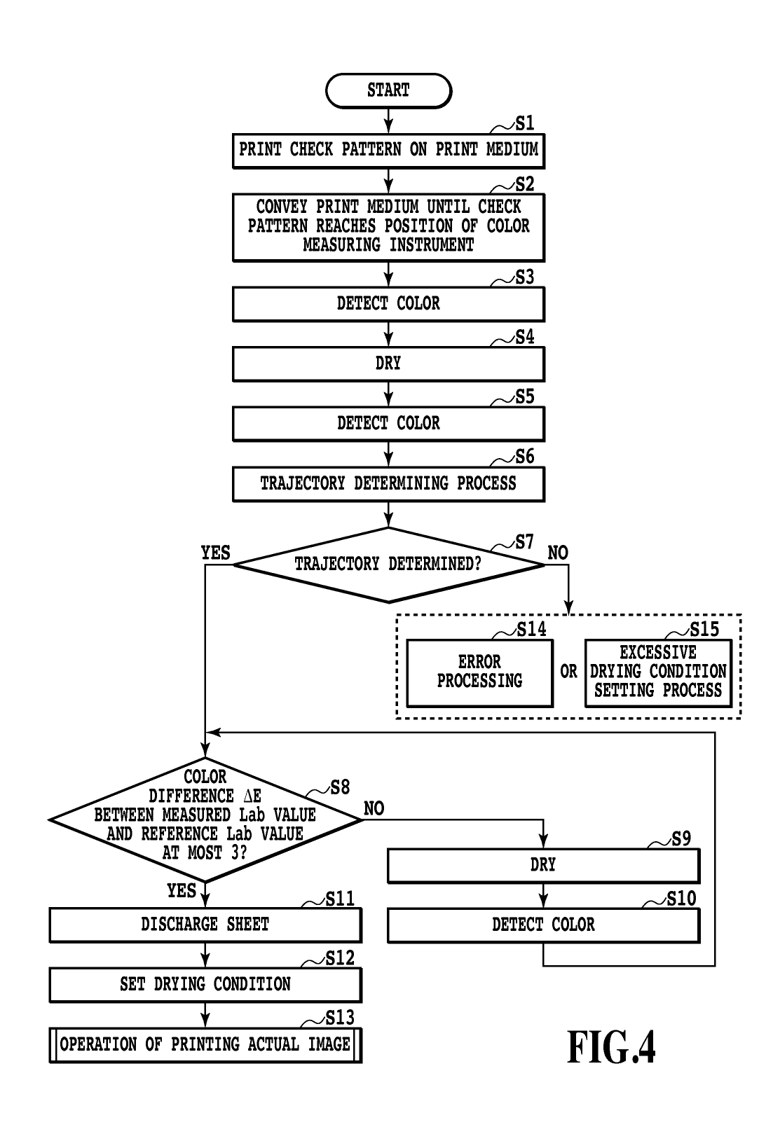

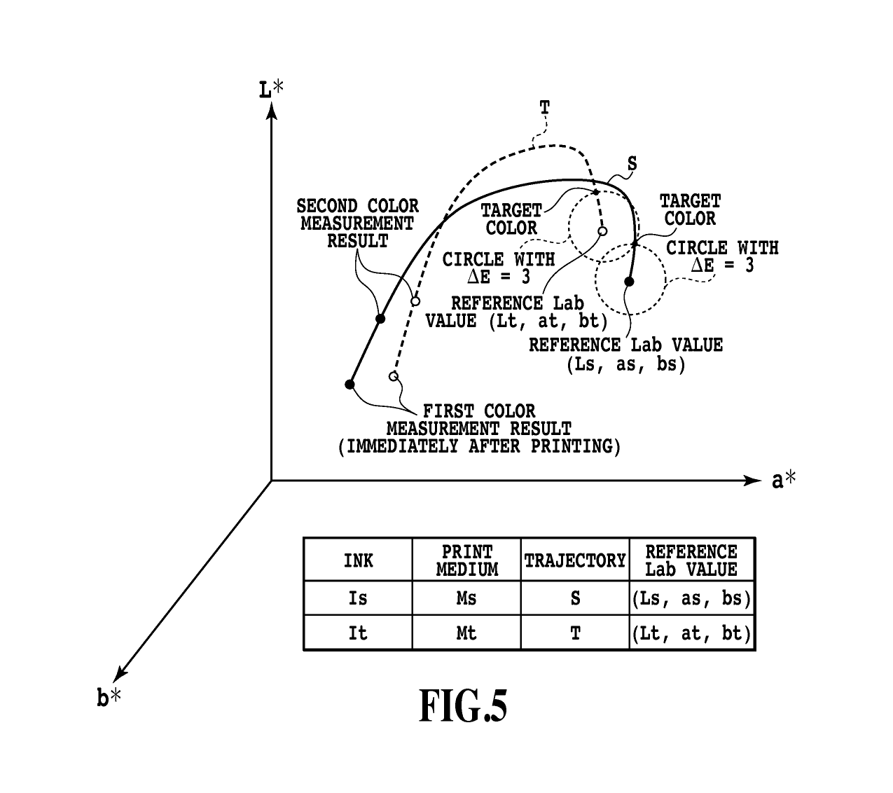

The memory 8 is composed of a ROM and a RAM. The ROM stores, for example, pattern data required to print such a check pattern as shown in FIG. 2, a control program required to carry out such processing as shown in the flowchart in FIG. 4, and information on the trajectory of variation in color as shown in FIG. 5. On the other hand, the RAM is utilized as a work area in which the CPU portion 1 executes calculations, determinations, setting processes, and the like. The RAM is further utilized to temporarily store actual image data (image data required to print the actual image) and various pieces of information such as a drying condition for the print medium described below. The conveying portion 19 makes up conveying means for conveying the print medium.

FIG. 3A is a schematic diagram of the configuration of an ink jet printing apparatus 100 according to the present embodiment. The printing apparatus 100 in the present example has the printing portion 5 including an ink jet print head 10, the color detecting portion 6 including a color measuring instrument 11, the drying portion 7 including a dryer 12, and the conveying portion 19 including a conveying belt 13.

The conveying belt 13 of the conveying portion 19 is configured to convey a print medium 9 such as paper in the directions of arrow Y1 and Y2. As is apparent from FIG. 3A, the print head 10, the measuring instrument 11, and the dryer 12 are provided along the conveying direction of arrow Y1. The print medium 9 is conveyed, by the conveying belt 13, among a print position (P0) located opposite the print head 10, a stop position 1 (P1) located opposite the measuring instrument 11, a stop position 2 (P2) located opposite the dryer 12, and a sheet discharging position (P3). The printing portion 5 can eject ink from the print head 10 based on the image data to print an image (check pattern and actual image) on the print medium 9 located at the print position (P0). The color detecting portion 6 uses the color measuring instrument 11 to measure the color of the check pattern printed on the print medium 9 located at the stop position 1 (P1), to obtain a Lab value for a CIELAB color space. The drying portion 7 uses the dryer 12 to blow hot or cool air against the print medium located at the stop position 2 (P2), to dry the print medium 9 with the image (check pattern and actual image) printed thereon.

The print head 10 may be, for example, one that ejects ink utilizing thermal energy or one that ejects ink using an electromechanical converter (heater) such as a piezo element. In the former print head, an electrothermal conversion element generates heat to bubble ink so that the resulting bubbling energy can be utilized to eject ink through an ejection port. If this print head is used, the definition of print images can be increased by increasing the density of nozzles. The print head 10 may be replaceable so that when installed in the printing portion 5, the print head 10 can be electrically connected to the printing apparatus and supplied with ink by the printing apparatus. Alternatively, the print head 10 may be of an ink jet cartridge type in which the print head 10 is integrated with an ink tank.

The types and numbers of print heads and ink tanks in the printing portion 5 are not particularly limited. The present embodiment uses a print head that can eject four types of ink in the respective colors including cyan (C), magenta (M), yellow (Y), and black (K), and an ink tank accommodating the four types of color ink.

A printing system used by the printing portion 5 is not limited but may be what is called a serial scan system or a full line system. In the serial scan system, the print head 10 is mounted on a carriage movable in a direction crossing the conveying direction of the print medium (for example, a direction orthogonal to the conveying direction). An image is sequentially printed on the print medium by repeating a printing operation of ejecting ink from the print head 10 while moving the carriage together with the print head 10, and an operation of conveying the print medium on the conveying belt 13. On the other hand, the full line system uses a long print head corresponding to the maximum width of a print area on the print medium. Then, with the print medium continuously conveyed by the conveying belt 13, ink is ejected from the long print head to the print medium. The long print head may be, for example, a plurality of print heads combined together so as to meet a length condition, or a single print head.

FIG. 2 is a diagram showing an example of a check pattern (also referred to as a “(drying condition setting) test pattern”) printed on the print medium to allow the drying condition for the print medium described below to be set. The check pattern in the present example includes patch portions printed in the respective solid ink colors, cyan (C), magenta (M), yellow (Y), and black (K). The check pattern further includes patch portions printed in the respective solid ink colors, red (R), green (C), blue (B), and process black (PcBk) obtained by mixing the above-described colors. In the printing apparatus in the present example, the maximum number of dots formed at one pixel using one type of ink is one. That is, the maximum print duty is 100%. Thus, each of the patch portions in cyan (C), magenta (M), yellow (Y), and black (K) has a print duty of 100%. The red (R) patch portion is printed using the 100% magenta (M) ink and the 100% yellow (Y) ink and thus has a total print duty of 200%. Similarly, the green (G) patch portion printed using the cyan (C) ink and the yellow (Y) ink and the blue (B) patch portion printed using the cyan (C) ink and the magenta (M) ink each have a total print duty of 200%. The process black (PcBk) patch portion printed using the cyan (C) ink, magenta (M) ink, and yellow (Y) ink has a total print duty of 300%. Thus, each of the patch portions is printed with the maximum print duty in the printing apparatus.

Some printing apparatuses have a maximum print duty of higher than 100%. For example, a printing apparatus capable of printing up to two dots in one pixel using one type of ink has a maximum print duty of 200%. Any printing apparatuses desirably print each patch portion with the maximum print duty. Pattern data required to print the check pattern is pre-stored in the memory 8. When the check pattern is printed, the pattern data is read from the memory 8, and according to the pattern data, the check pattern is printed.

In the ink jet printing apparatus, first, the power supply switch 3 is turned on to feed electricity from the power supply portion 2 to the component portions. Thereafter, as an initial operation, a process of setting the drying condition for the print medium is carried out.

With reference to FIG. 4, the process of setting the drying condition will be described.

First, the CPU portion 1 sends an instruction to start printing the check pattern and check pattern printing pattern data read from the memory 8, to the printing portion 5. In parallel, the CPU portion 1 sends an instruction to convey the print medium to the conveying portion 19. In accordance with the print start instruction and pattern data from the CPU portion 1, the printing portion 5 prints such a check pattern as shown in FIG. 2, on the print medium 9 conveyed to the print position (P0) by the conveying portion 19 (S1).

Thereafter, the print medium with the check pattern printed thereon is conveyed to the stop position (P1) (S2). The color (Lab value) of the just printed check pattern is detected by the color measuring instrument 11 (S3). The detection result is sent to the CPU portion 1. Thereafter, the print medium with the check pattern printed thereon is conveyed to the stop position 2 (P2). The print medium is then dried for a given time (for example, (a) seconds) by the drier 12 (S4). Thereafter, the print medium with the check pattern printed thereon is conveyed to the stop position 1 (P1) again. The color (Lab value) of the check pattern is detected by the color measuring instrument 11 (S5). The detection result is sent to the CPU portion 1.

Based on the first and second detection results (measured Lab values) from the color measuring instrument 11, the CPU portion 1 selects the trajectory corresponding to the combination of the ink and print medium used to print the check pattern, from the information stored in the memory 8 and relating to trajectories S and T of variation in color (variation in reference Lab value) shown in FIG. 5 (S6).

The trajectory information on variation in color as shown in FIG. 5 relates to the trajectory (the trajectory of variation in Lab value) of variation in color in the CIELAB color space for images printed using combinations of various types of ink and various print media and then naturally dried. In the example in FIG. 5, the color of an image printed on a print medium Ms using ink Is and then naturally dried varies so as to describe the trajectory S. When naturally dried for 24 hours, the image exhibits a color corresponding to a reference Lab value (Ls, as, bs). The color of an image printed on a print medium Mt using ink It and then naturally dried varies so as to describe a trajectory T. When naturally dried for 24 hours, the image exhibits a color corresponding to a reference Lab value (Lt, at, bt). The color of the image naturally dried for 24 hours can be considered to be a color with substantially no temporal variation (stable color). In the present example, the Lab value of the stable color is defined as the reference Lab value.

The trajectory of variation in the color of the print image and the reference Lab value vary depending on the combination of ink and a print medium. Furthermore, the trajectory of variation in color in the CIELAB color space during natural drying is almost similar to that during forced drying. Thus, by comparing the trajectory of the Lab value during natural drying as shown in FIG. 5 with the results of the first and second color measurements of the check pattern (the detection results in steps S3 and S5), the trajectory corresponding to the combination of the ink and print medium used to print the check pattern can be determined (S6). Moreover, the reference Lab value contained in the trajectory information corresponding to the combination of the ink and the print medium used to print the check pattern can be read from the memory 8.

For example, when the results (Lab values) of the first and second color measurements of the check pattern vary along the trajectory S, the ink It and the print medium Mt are determined to be used to print the check pattern. Then, the reference Lab value (Lt, at, bt) contained in the trajectory S corresponding to this combination is read from the memory 8. Furthermore, to determine the trajectory corresponding to the combination of the ink and the print medium, at least three measurements are desirably performed so that variations in the at least three measurement results can be compared with the trajectory of variation in color. A drying process for a given time (for example, (a) seconds) is carried out between two consecutive color measurements like the first color measurement (S3) and the second color measurement (S5). When at least three color measurements are thus performed, even if for example, a plurality of trajectories (for example, trajectories S and T) of variation in color are similar to each other, the trajectory corresponding to the combination of the ink and the print medium can be more accurately determined by associating the trajectories with the variations in the at least three color measurement results. The plurality of trajectories (for example, the trajectories S and T) of variation in color may tend to run close to each other immediately after printing and to run away from each other as drying progresses over time.

In the description of the present embodiment, the two trajectories S and T of variation in color are stored in the memory 8. However, the trajectories of variation in color which can be stored in the memory 8 are not limited to two types. Of course, the memory 8 can store information (including the reference Lab value) relating to a large number of trajectories of variation in color and corresponding to the combinations of various types of ink and various print media (for example, plain paper and glossy paper) that can be used for the printing apparatus.

FIG. 4 is referred to again. After the determination process in step S6, the process proceeds to step S7 to determine whether or not the trajectory corresponding to the color measurement result has been determined (S7). The number of trajectories stored in the memory 8 is limited. Thus, of course, the trajectory corresponding to the combination of the ink and print medium used to print the check pattern may not be stored in the memory 8. In this case, since no trajectory matches the color measurement result, the trajectory is not determined. If the trajectory is not determined, the process shifts from step S7 to step S14 or S15. In step S14, error processing involving issuance of an alarm or the like is carried out. In step S15, a predetermined drying time (for example, a uniform drying time of (c) minutes) is set to be an excessive drying condition (S15). The (c) minutes is an excessive drying time that is sufficiently long to change the color of the print image to the stable one.

On the other hand, if the trajectory has been determined in step S7, the reference Lab value contained in the trajectory is read from the memory 8. Upon being read from the memory 8 as described above, the reference Lab value is compared with the latest color measurement result (Lab value) to determine whether or not the resulting color difference ΔE is at most 3 (S8). That is, the apparatus determines whether or not the color measurement result has been changed to a color (hereinafter referred to as a “target color”) with a color difference ΔE of at most 3 from the reference Lab value. For example, a circle is presumably set around the reference Lab value (Ls, as, bs) so as to have a radius of ΔE=3 as shown by a dotted line in FIG. 5. Then, the Lab value located at the intersecting point between the circle and the trajectory S corresponds to the target color.

If the color difference ΔE between the latest color measurement result (Lab value) and the reference Lab value is larger than 3, a further drying operation is performed for (a) seconds by the dryer 12, and color measurement is carried out again (S9 and S10). The process then returns to the above-described determination process (S8). In this manner, the drying operation (S9) and the color measurement (S10) are repeated until the color difference ΔE between the latest measurement result and the reference Lab value is at most 3. When the color difference ΔE from the reference Lab value is at most 3, the drying operation is stopped, and the print medium is discharged (S11). The total time required to achieve sufficient drying is set to be a drying condition. That is, if the drying operation repeated in step S9 as required is referred to as the second drying operation, the third drying operation, . . . (n=2, 3, . . . ), the total drying time is n×a (seconds), which is set to be a drying condition for an operation of printing an actual image (S13).

In the present example, the drying time as a drying condition is determined for each of the eight patch portions in FIG. 2. Then, the longest of the drying time determined is set to be the drying condition for printing of the actual image. Once an initial operation including the setting of the drying condition is completed, the actual image can be printed using the ink and print medium used to print the check pattern.

To allow the actual image to be printed, first, information containing the print start instruction and image data from an external apparatus such as a word processing apparatus or an image producing apparatus is input to the CPU portion 1 via the I/F 4. In accordance with the print start instruction and the image data, the CPU portion 1 controls the printing portion 5 and the conveying portion 9 so that the printing portion 5 ejects ink to the print medium 9 conveyed by the conveying portion 9, to print the actual image on the print medium 9. Then, the CPU portion 1 controls the conveying portion 9 so that the conveying portion 9 conveys the print medium 9 with the actual image printed thereon to the drying portion 7.

Then, the CPU section 1 controls the drying portion 7 in accordance with the drying condition set by the abovedescribed initial operation so that the drying portion 7 executes a drying process on the print medium with the actual image printed thereon. That is, the print medium with the actual image printed thereon is dried by the drying portion 7 for the drying time (n×a (seconds)) set as the drying condition. Once the drying process is completed, the CPU portion 1 controls the conveying portion 9 so that the print medium subjected to the drying process is discharged from the printing apparatus. Thus, the print medium with the actual image printed thereon is discharged when the color of the actual image matches the target one, which has a color difference ΔE of at most 3 from the reference Lab value. Thus, variation in the color of the actual image on the print medium discharged from the printing apparatus can be reduced to at most 3 in terms of ΔE. The user can thus be prevented from perceiving the variation in color.

Furthermore, as described above, the longest of the drying time determined for the respective eight patch portions in FIG. 2 is set to be a drying condition for printing of the actual image. This makes any portion of the actual image exhibit the target color. The color of the print image is considered to be varied by evaporation of moisture from the ink. Thus, forcibly drying the ink as in the present example is effective for stabilizing the color of the print image in a short time.

Furthermore, in the present example, the drying condition is set using the check pattern printed with the maximum print duty of the printing apparatus. Then, regardless of whatever actual image is printed by the printing apparatus, variation in the color of the actual image on the print medium discharged from the printing apparatus can be reduced to 3 in terms of ΔE.

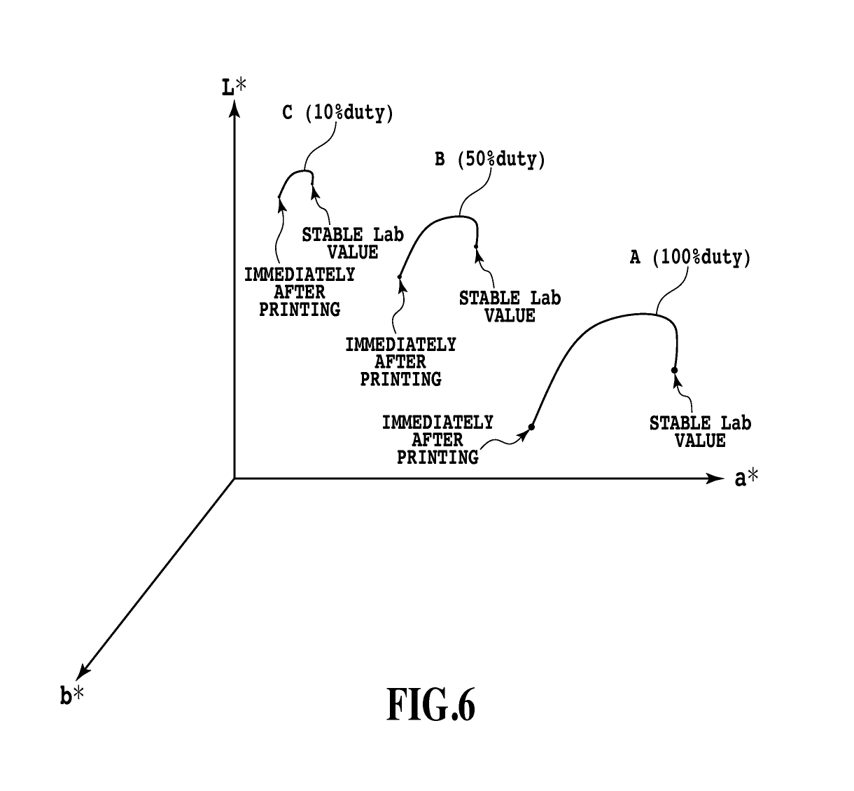

For example, if a single color image varies so as to describe a trajectory A in FIG. 6 when printed with the maximum print duty of 100% as in the case of the single color patch portions (cyan (C), magenta (M), yellow (Y), or black (K) patch portions), the single color image varies so as to describe a trajectory B or C when the print duty thereof is 50% or 10%, respectively. The lengths of the trajectories A, B, and C correspond substantially to the lengths of time elapsed from the end of printing. When 24 hours elapses, the trajectory A reaches the reference Lab value, corresponding to a color (stable color) with substantially no temporal variation. When almost half of 24 hours and one-tenths of 24 hours elapse, the trajectories B and C, respectively, reach the stable Lab value corresponding to the stable color. For the trajectories A, B, and C, the color varies significantly immediately after printing and the variation becomes more insignificant as the time elapses. Upon reaching the stable color, the trajectory exhibits substantially no temporal variation in color.

For an image in various colors printed by mixing the colors of plural types of ink, the trajectory of variation in color varies depending on the combination of ink colors mixed. That is, the time from the end of printing of the image until the color of the image reaches the stable one varies depending on the combination of the types of ink used to print the image. For example, an image printed as is the case with the process black (PcBk) patch portion tends to involve a relatively short time from the end of printing until the color of the image reaches the stable one regardless of the high total print duty of 300%.

In the present example, the drying condition is set using the patch portion (including a single-color patch portion and a mixed-color patch portion) printed with the maximum print duty in the printing apparatus. Thus, the variation in color can be reduced to 3 in terms of ΔE for the entire actual image that can be printed by the printing apparatus.

Alternatively, the drying condition can be set utilizing the fact that the length of the trajectory of variation in the color of the print image, that is, the length of the trajectory from the end of printing until the color of the image reaches the stable one, corresponds substantially to the length of time elapsed from the end of printing. That is, from plural pieces of information on the trajectories of variation in color which correspond to the plurality of patch portions, one piece of information on the longest trajectory may be selected so that the drying condition can be set based only on this piece of information. If only three of the four ink colors, cyan (C), magenta (M), yellow (Y), and black (K) are used for the operation of printing the actual image, the longest of the drying times for the three ink colors can be set to be the drying condition. That is, if the actual image is not printed using all the ink types used to print the check pattern, the longest of the drying time for the ink types used to print the actual image can be set to be the drying condition. This enables the drying time required for the operation of printing the actual image to be reduced to the minimum required value. The ink types used for the operation of printing the actual image can be detected based on the print data on the actual image.

In the present example, after the printing apparatus is powered on and before the actual printing operation is started, the check pattern is printed to allow the drying condition (drying time) to be set. This is because the actual image is assumed to be printed for a long time using the combination of the ink and print medium used to print the check pattern.

The operation of setting the drying condition may be automatically performed every time the printing apparatus is powered on. Alternatively, a control mode for allowing the setting operation to be performed based on the user's instruction may be provided so that the setting operation can be performed during any period desired by the user. For example, a rapid change in climate may raise the humidity around the printing apparatus, thus increasing the time required to dry the ink. In this case, the drying condition set before the climate changes may fail to allow the color of the print image to be stabilized. To provide for such a case, the above-described control mode can be effectively provided. That is, for example, by operating an appropriate button, the user may allow the operation of setting the drying condition to be performed during the required period, to re-set the drying condition. A specific sequence may be such that the processing shown in FIG. 4 is carried out when the user, for example, operates the appropriate button to allow the operation of setting the drying condition to be performed. That is, after the processing in step S1 is carried out to print the check pattern in FIG. 2 at a predetermined position on the print medium, the subsequent processing may be carried out in accordance with the sequence of step 2 and the subsequent steps.

FIGS. 3B and 3C are diagrams illustrating other examples of the configuration of the ink jet printing apparatus. In the configuration in FIG. 3B, the print head 10, the dryer 12, and the measuring instrument 11 are provided along the conveying direction of arrow Y1. In the configuration in FIG. 3C, the measuring instrument 11 is provided in the dryer 12. Like the configuration in FIG. 3A, these configurations can perform the operation of setting the drying condition based on the printing of the check pattern and the operation of printing the actual image, as described above. In the configuration in FIG. 3C, after the print medium 9 is conveyed to the stop position 3 (P4) by the conveying belt 13, the color measuring process by the color measuring instrument 11 and the drying process by the dryer 12 can be carried out separately or simultaneously.

### Second Embodiment

In the present embodiment, when the drying condition is set, environmental conditions relating to humidity and temperature are taken into account. Thus, the configuration according to the present embodiment corresponds to the configuration of the printing apparatus according to the first embodiment in which a humidity sensor and a temperature sensor are provided. The remaining part of the configuration according to the present embodiment is the same as that according to the first embodiment.

In the present example, the drying condition is set according to four environmental conditions with different combinations of humidity and temperature ((1) low humidity and low temperature, (2) low humidity and high temperature, (3) high humidity and low temperature, and (4) high humidity and high temperature). Thus, information on the trajectory of variation in color corresponding to the combination of the ink and the print medium as shown in FIG. 5 is preset for each of the four environmental conditions. The information is stored in the memory 8 in the form of a combination table for the trajectory of variation in color. The drying condition is set as follows. First, the humidity and the temperature are detected by the humidity sensor and the temperature sensor. Based on the detection results, which of the four environmental conditions the environment of the printing apparatus corresponds can be determined. Thereafter, the color of the check pattern is measured twice as is the case with the first embodiment. Based on the two color measurement results and the combination table, containing the trajectory of variation in color corresponding to the determined environmental condition, the trajectory corresponding to the combination of the ink and print medium used is determined. The trajectory is then utilized to set the drying condition.

Thus, even for the same combination of the ink and the print medium, a more optimum drying condition can be set according to the environmental condition relating to the humidity and temperature.

### Third Embodiment

The present embodiment determines the reference Lab value in a manner different from that according to the first embodiment.

In the present example, in the configuration of the printing apparatus 100 in FIG. 3A, first, the print head 10 prints the check pattern in FIG. 2 on the print medium 9 conveyed to the print position (P0) by the conveying belt 13. Then, the print medium 9 is conveyed on the conveying belt 13 so as to locate the check pattern at the stop position 2 (P2). The print medium 9 is dried at t° C. for (d) minutes by the drier 12 and then left for (e) minutes. For example, the print medium 9 is dried at 60° C. for 10 minutes and then left for 10 minutes.

It is expected that with combinations of commercially available ink and print media, a drying operation at 60° C. for 10 minutes is sufficient to stabilize the color of the print image. Furthermore, it is expected that when an excessive drying operation is performed, about 10 minutes elapses until the ink and the print medium become compatible with the normal temperature and humidity. When the check pattern is dried at 60° C. for 10 minutes and then left for 10 minutes, the Lab value of the color of the resulting check pattern is expected to be the same as the above-described reference Lab value. In the present embodiment, the reference Lab value thus determined is used to set the drying condition. Specifically, first, the check pattern is dried at 60° C. for 10 minutes and then left for 10 minutes. Thereafter, the color of the check pattern is measured, with the color measurement result stored in the memory as the reference Lab value. Then, the check pattern is printed again under the same conditions, and the color measurement and drying operation are performed on the second printed check pattern as is the case with the above-described embodiment Then, the drying time is determined which elapses until the color difference between the color measurement result (Lab value) and the reference Lab value reaches at most 3 in terms of ΔE.

As described above, in the present example, the check pattern is printed twice under the same conditions. The reference Lab value is determined based on the first printed check pattern, with the drying time determined based on the second printed check pattern. Thus, even if the information corresponding to the combination of the ink and the print medium as shown in FIG. 5 is not stored in the memory 8, the drying condition corresponding to the combination of the ink and the print medium can be set. Furthermore, the thus set drying condition may be stored in the memory 8 in association with the combination of the ink and the print medium so as to be read later from the memory 8 for use when an image is printed using the same combination of the ink and the print medium. This eliminates the need to print the check pattern in order to allow the drying condition to be set.

### Fourth Embodiment

The present embodiment is different from the above-described first embodiment in the processing carried out when the determination in step S7 in FIG. 4 is negative.

In the present embodiment, in step S7 in FIG. 4, when the information on the trajectory of variation in color corresponding to the color measurement result is not stored in the memory 8 and the trajectory matching the color measurement result cannot be determined, the print medium with the check pattern printed thereon is left for 24 hours. Thereafter, the color of the check pattern is measured, with the color measurement result stored in the memory 8 as the reference Lab value. Then, as is the case with the above-described third embodiment, the check pattern is printed again under the same conditions. The color measurement and the drying operation are performed again on the second printed check pattern. The drying time is then determined which elapses until the color difference between the color measurement result (Lab value) and the reference Lab value reaches at most 3 in terms of ΔE.

### Fifth Embodiment

The above-described embodiments are configured such that the drying condition corresponding to the combination of the ink and the print medium is determined in the printing apparatus. However, the drying condition may be determined outside the printing apparatus. In this case, first, the drying condition (C1 to C9) corresponding to the combination of the ink (Ia, Ib, and Ic) and the print medium (Ma, Mb, and Mc) as shown below in Table 1 is determined outside the printing apparatus and stored in the memory 8 of the printing apparatus. The drying condition (C1 to C9) is the drying time.

TABLE 1

| | | Print medium | | |
|---|---|---|---|---|
| | | Ma | Mb | Mc |
| Ink | Ia | C1 | C2 | C3 |
| | Ib | C4 | C5 | C6 |
| | Ic | C7 | C8 | C9 |

When a print instruction is input to the printing apparatus, the drying condition corresponding to the ink and print medium used to print the actual image is read from the memory 8. Then, based on the read drying condition (drying time), the print medium with the actual image printed thereon is dried.

If the types of the ink and print medium used to print the actual image are known, the user may input the types to the printing apparatus. If the combination of the ink and the print medium is fixed to one particular type, the combination of the ink and print medium used need not be determined. It is only necessary to read and use one drying condition corresponding to the combination. This eliminates the need to print the check pattern as in the case of the above-described embodiment and the need for the color detecting portion 6.

Alternatively, the types of the ink and print medium used to print the actual image may be detected by a sensor and automatically input to the apparatus. Alternatively, as is the case with the above-described first embodiment, the types of the ink and the print medium may be determined by printing the check pattern using the ink and print medium used to print the actual image and then comparing the result of color measurement of the check pattern with the information on the trajectory of variation in color as shown in FIG. 5.

### Other Embodiments

A scheme such as hot air drying, cold air (air blow) drying, or natural drying may be adopted as a drying scheme for the drying portion 7. Alternatively, the drying time can be controlled by adjusting the speed at which the print medium is conveyed in the dryer. Alternatively, drying temperature or the air blow amount of hot or cold air may be set to be a drying condition for the drying portion 7. Furthermore, the drying portion 7 may subject the image to natural drying instead of forced drying. Additionally, to make the color stable, preferably, the forcibly dried print medium is retained in place and the humidity of the print medium is adjusted using humidity adjusting means.

In an alternative configuration, the drying portion 7 is provided in the printing apparatus, whereas the color detecting portion 6 is not provided in the printing apparatus. In this configuration, the drying portion 7 in the printing apparatus dries the print medium, which is then discharged to the exterior of the printing apparatus. Then, the print image (including the check pattern and the actual image) on the discharged print medium is detected by a color detecting apparatus (Lab measuring instrument) located outside the printing apparatus.

The present invention is widely applied to ink jet printing apparatuses and methods in which ink is applied to a print medium to print an image on the print medium. In the present invention, the ink applying scheme and the printing scheme are not limited. One or more types of ink sets may be used in the present invention. Similarly, one or more types of print media may be used in the printing apparatus according to the present invention. That is, the present invention embraces an aspect using one type of ink set and plural types of print media, an aspect using one type of ink set and one type of print medium, and an aspect using plural types of ink sets and plural types of print media.

Various types of ink including, for example, aqueous ink may be used. Various print media including glossy paper may be used. The “glossy paper” as used herein is defined as glossy paper composed of a substrate such as plain paper or resin coat paper coated with a receptive layer receiving ink so as to be suitable for ink jet printing, with the surface of the paper made smooth.

Furthermore, to further stabilize the effects of the present invention, the printing apparatus preferably include ejection recovery means for recovering the ink ejection performance of the print head, preliminary assisting means, or the like. Specific examples of such means include capping means for capping an ejection port surface of the print head in which ejection ports are formed and cleaning means for wiping the ejection port surface. Other examples include pressurized discharging means for pressurizing the ink in the print head to discharge ink not contributing to the printing of images, through the ejection ports, and suction discharging means for introducing a negative pressure into the cap to suck and discharge the ink not contributing to the printing of images, into the cap through the ejection ports. Another example is preliminary ejecting means for ejecting the ink not contributing to the printing of images, through the ejection ports (preliminary ejection). Yet another example is preliminary heating means for heating the ink in the print head using an electrothermal converting element (heater) different from the one for ejecting the ink or both the electrothermal converting elements (heaters).

Furthermore, according to the aspects of the present invention, the ink jet printing apparatus may be used as an image output terminal for information processing equipment such as a computer or may be a copying apparatus combined with an image reader or the like, or a facsimile machine having a transmission and reception function.

Examples of the configurations of a base material for the print medium, an ink absorbing layer in the print medium, and ink will be described below.

### (Base Material for the Print Medium)

The base material for the print medium used in the present invention is not particularly limited. For example, the base material may be appropriately sized paper, size-less paper, coated paper, or paper such as resin coat paper which contains polyethylene. A transparent thermoplastic resin film may also be used, such as polyethylene, polyester, polystyrene, polylactate, polyacetate, polyvinyl chloride, acetyl cellulose, polyethylene terephthalate, polymethyl methacrylate, or polycarbonate. The base material may also be a sheet-like substance (synthetic paper or the like) made of up a film made opaque by filling of an inorganic substance or fine foaming, or a sheet made up of a cloth, glass, metal, or the like. To enhance the adhesive strength between the base material and the ink absorbing layer, the surface of the base material may be subjected to corona discharge treatment or any of various undercoat treatments.

### (Ink Absorbing Layer in the Print Medium)

In the print medium used in the present invention, a cationic resin and polyether may be introduced into the surface of the base material together with an inorganic pigment to form an ink absorbing layer.

Examples of available polyether include polyalkylene glycol such as polyethylene glycol or polypropyleneglycol, and polyalkylene oxide such as polyalkylene oxide, polypropylene oxide or polybuthylene oxide. Alternatively, a resin may be obtained by polymerizing plural types of polyether having different molecular structures or molecular weights, or plural types of polyether may be mixed together. Among these types of polyether, polyethylene glycol or polyethylene oxide may preferably be used.

The content of polyethylene glycol or polyethylene oxide is preferably 0.5 to 10 mass % with respect to the inorganic pigment in the ink absorbing layer. More preferably, the content is 1 to 5 mass %. When the content exceeds 10 mass %, significant effects are not exerted but rather the quality of printed characters may be degraded. When the content is less than 0.5 mass %, sufficient effects are not exerted. The average molecular weight (Mn) of the above-described polyether is preferably 1,000 to 50,000, more preferably 2,000 to 30,000. When the average molecular weight (Mn) is at most 1,000, sufficient effects are not exerted but rather the quality of printed characters may be degraded. On the other hand, when the average molecular weight (Mn) exceeds 50,000, a coating liquid forming the ink absorbing layer exhibits an increased viscosity. This may degrade coating capability.

Examples of the cation rein include polyallylamine, polyaminesulfone, polyvinylamine, polyethyleneimine, a polyamideepichlorohydrin resin, polyvinylpyridiniumhalide, polydimethylallylammoniumchloride, a cation modified substance of polyacrylamide or a copolymer of acrylamide and a cationic monomer, a copolymer of a vinylpyrolidone-containing monomer and another common monomer, and a copolymer of a vinyloxazolidone-containing monomer and another common monomer. Preferable examples of the cation resin include a polyallylamine acetate polymer and a polyacrylamide-diallylamine hydrochloride copolymer, which are very effective for stabilizing the coating liquid and improving the quality of printed characters. Each of these cationic resins may be independently used or any of the cationic resins may be mixed together, or a plurality of other cationic resins may be mixed together for use.

The print medium used in the present invention is obtained by preparing a coating liquid containing the above-described components and coating the coating liquid on the surface of the base material to form an ink absorbing layer. The ink absorbing layer preferably has cavities formed by an inorganic pigment and a small amount of water-soluble resin.

The inorganic pigment is preferably inorganic particulates which offers a high ink absorbing power and an excellent coloring capability and which enables high-quality images to be printed. Examples of inorganic particulates include magnesium carbonate, kaolin, hydrotalcite, calcium silicate, magnesium silicate, alumina, colloidal alumina, aluminum hydroxide, an alumina hydrate of a boehmite structure and an alumina hydrate of a quasi-boehmite structure, synthetic amorphous silica, colloidal silica, lithopone, and zeolite. Each of these substances may be independently used or a plurality of the substances may be used together. The alumina or the alumina hydrate of the boehmite or quasi-boehmite structure is preferable in terms of the capability of allowing finer cavities to be formed. In particular, alumina or an alumina hydrate of the boehmite or quasi-boehmite structure which has a BET specific surface area of at least 50 m²/g is particularly preferred.

The alumina hydrate may be expressed by General Formula (1).

Al₂O₃-n(OH)₂n.mH₂O (1)

In General Formula (1), n denotes any one of the integers 0, 1, 2, and 3, and m denotes a value between 0 and 10, preferably between 0 and 5. In most cases, mH2O expresses a desorbable aqueous phase that is not involved in the formation of crystal lattices. Thus, m may have a non-integral value. Furthermore, when an alumina hydrate of this kind is heated, m may reach zero.

In general, the crystal of the alumina hydrate of the boehmite structure is a layered compound having a (020) face forming a megaplane. The crystal exhibits a specific diffraction peak in an X-ray diffraction figure. Instead of the perfect boehmite structure, a structure called quasi-boehmite may be adopted which has an excess amount of water contained layers in the (020) face. The X-ray diffraction figure of the quasi-boehmite exhibits a broader diffraction peak than that of the perfect boehmite. The perfect boehmite and the quasi-boehmite cannot be definitely distinguished from each other. Thus, both are collectively called the alumina hydrate exhibiting the boehmite structure unless otherwise specified.

The boehmite structure may be the one disclosed in Japanese Patent Laid-Open No. S56-120508 (1981), that is, the one into which an alumina hydrate that is amorphous in connection with X-ray diffraction is converted by being heated at 50° C. or higher in the presence of water. A particularly preferable method is to add an acid to aluminum alkoxide with a long chain to cause hydrolysis and deflocculation to obtain an alumina hydrate.

Here, the aluminum alkoxide with the long chain is, for example, an alkoxide with a carbon number of at least 5. Moreover, an alkoxide with a carbon number of 12 to 22 is preferable in terms of the capability of facilitating the removal of alcohol and the control of the shape of the alumina hydrate as described below. The added acid may be one or more types freely selected from the organic and inorganic acids. Nitric acid is most preferable in terms of the reaction efficiency of the hydrolysis, the control of the shape of the alumina hydrate obtained, and the dispersability of the alumina hydrate. After this process, hydrothermal synthesis can be performed to control particle size. When the hydrothermal synthesis is performed using an alumina hydrate dispersion liquid containing nitric acid, the nitric acid in the water solution is incorporated into the surface of the alumina hydrate as a nitric acid radical. This allows water dispersability to be improved.

Compared to a method of manufacturing alumina hydrogel or cationic alumina, the above-described method has the advantage of hindering the mixture of impurities such as various ions. Moreover, the aluminum alokoxied with the long chain facilitates the removal of alcohol after the hydrolysis, and thus compared to an alkoxide with a short chain such as aluminum isopropoxide, has the advantage of allowing the alumnina hydrate to be completely dealcholized.

Furthermore, by coating a coating liquid on the surface of the base material, an ink absorbing layer of the print medium can be formed. The coating liquid can be prepared by mixing a composition made up at least of the inorganic pigment, cationic resin, and polyether, with required amounts of water-soluble resin and aqueous medium.

Examples of a water-soluble or water-dispersive polymer compound contained in the coating liquid include starch, gelatine, casein and a modified substance thereof, a cellulose derivative such as methylcellulose, carboxymethylcellulose, or hydroxymethylcellulose, perfectly or partly saponified polyvinyl alcohol or a modified substance (cation modification, anion modification, silanol modification, or the like), a urea-containing resin, a melamine-containing resin, an epoxy-containing resin, an epichlorohydrin-containing resin, a polyurethane-containing resin, a polyethyleneimine-containing resin, a polyamide-containing resin, a polyvinylpyrolidone-containing resin, a polyvinylbutyral-containing resin, poly(metha)acrylic acid or a copolymer thereof, an acrylamide-containing resin, a maleic acid-containing copolymer, a polyester-containing resin, an SBR latex, an NBR latex, a methylmethacrylate-butadiene copolymer latex, an acrylic-containing polymer latex such as an ester acrylate copolymer, a vinyl-containing polymer latex such as an ethylene-vinyl acetate copolymer, and functional group-modified polymer latexes obtained by applying a cationic group or an anionic group to any of the various polymer latexes. A preferable polymer compound is a polyvinyl alcohol obtained by hydrolyzing polyvinyl acetate and having an average degree of polymerization of 300 to 5,000. The polyvinyl alcohol preferably has a degree of saponification of 70% to less than 100%, particularly preferably 80 to 99.5%. Each of these water-soluble or -dispersive resins can be independently used or a plurality of the resins can be used together.

The mixture mass ratio of the inorganic pigment to the water-soluble resin in the coating liquid described above is preferably between 1:1 and 30:1, more preferably between 2:1 and 12:1. Provided that the amount of the water-soluble resin is within this range, the ink absorbing layer formed is hindered from being cracked or peeled off, and offers an excellent ink absorbing capability.

Furthermore, a hardener may be used to improve the fragility of the film of the ink absorbing layer. Any of various hardeners may be selectively used. Examples of the hardener include an epoxy-containing hardener, an aldehyde-containing hardener, an active halogen-containing hardener, an active vinyl-containing compound, an isocianate compound, and a boron compound. If the polyvinyl alcohol is used, a hardener selected from boric acid, a salt thereof, and borax is preferably used, and boron is more preferable. The content of the boric acid is preferably 0.1 to 50 mass %, more preferably 0.5 to 30 mass % with respect to the water-soluble or -dispersive polymer compound in the ink absorbing layer. If the content exceeds 50 mass %, the coating liquidmaybe gelled and exhibit a degraded coating suitability. If the content is less than 0.1 mass %, the effects of the hardener are not sufficiently exerted.

The aqueous medium serving as a base material for the coating liquid is not particularly limited provided that the medium is a mixture with water or a water-mixable organic solvent. Examples of the water-mixable organic solvent include alcohols such as methanol, ethanol, and propanol; lower alkylethers of multivalent alcohol such as ethyleneglycol methylether and ethyleneglycol dimethylether; ketones such as acetone and methylethylketone; and ethers such as tetrahydrofuran.

The solid concentration of the coating liquid which is required to form the ink absorbing layer is not particularly limited provided that the viscosity of the coating liquid is enough to form the ink absorbing layer on the base material. However, the solid concentration is preferably 5 to 50 mass %. If the solid concentration is less than 5 mass %, the amount of the coating liquid needs to be increased in order to increase the film thickness of the ink absorbing layer. In this case, much time and energy is required for the drying. This is uneconomical. If the solid concentration exceeds 50 mass %, the viscosity of the coating liquid increases, possibly degrading the coating capability.

To coat the above-described coating liquid on the base material, any of the well-known coating methods maybe used, including a spin coat method, a roll coat method, a blade coat method, an air knife coat method, a gate roll coat method, a bar coat method, a size press method, a spray coat method, a gravure coat method, a curtain coat method, a rod blade coat method, a lip coat method, and a slit die coat method. Furthermore, after the coating, a calendar roll or the like may be used to improve the surface smoothness of the ink absorbing layer as required.

The preferable range of the amount of coating liquid coated on the base material is, in terms of solids, between 0.5 g/m₂ and 60 g/m₂, more preferably, between 1.0 g/m₂ and 50 g/m₂. If the coating amount is less than 0.5 g/m₂, the ink absorbing layer fails to sufficiently absorb the moisture of the ink, possibly resulting in the flow of the ink or the bleeding of the image. On the other hand, if the coating amount exceeds 60 g/m₂, the print medium may be curled during the drying or the printing performance may fail to be significantly improved against expectation.

A method for using the polyether compound is to add the polyether compound directly to the coating liquid as described above, or to add the polyether compound to the print medium with the ink absorbing layer formed therein using the inorganic pigment. Either method is applicable. In the latter method, the polyether compound may be added to the coating liquid by dissolving or dispersing the polyether compound in the solvent, and then immersing the print medium in the solvent or overcoating the print medium with the solvent.

The print medium used in the present invention is obtained by coating the coating liquid on the base material as described above, and then using a drying apparatus such as a hot air drier, a heat drum, or a far-infrared drier to dry the base material. Furthermore, the ink absorbing layer formed on the base material may be provided on one side or both sides of the base material. If the ink absorbing layer is provided on both sides, the composition of the ink absorbing layer formed on one side may be the same as or different from that of the ink absorbing layer formed on the other side.

Furthermore, any of the following may be added to the ink absorbing layer in the print medium to the degree that the performance of the print medium is not degraded: a coloring die, a coloring pigment, a dispersant, a thickener, a pH adjuster, a lubricant, a flow modifying agent, a surfactant, an antistat, an antifoamer, a foam suppressor, a remover, a penetrant, a fluorescent whitening agent, an ultraviolet absorber, an antioxidant, and the like.

(Ink)

Example of the water-soluble organic solvent forming the ink include polyalkyleneglycols such as polyethyleneglycol and polypropyleneglycol; alkyleneglycols each having an alkylene group containing 2 to 6 carbon atoms, such as ethyleneglycol, propyleneglycol, buthyleneglycol, triethyleneglycol, 1,2,6-hexanetriol, hexyleneglycol, and diethyleneglycol; glycerin; lower alkylethers of multivalent alcohol such as ethyleneglycol methylether, diethyleneglycol methyl(or ethyl)ether, and triethyleneglycol monomethyl (or ethyl)ether; alcohols such as n-propyl alcohol, isopropyl alcohol, n-butyl alcohol, sec-butyl alcohol, tert-butyl alcohol, isobutyl alcohol, benzyl alcohol, and cyclohexanol; amides such as dimethylformamide and dimethylasetoamide; ketones or ketone alcohols such as acetone and diacetonealcohols; ethers such as tetrahydrofuran and dioxane; and nitrogen-containing cyclic compounds such as N-methyl-2-pyrolidone, 2-pyrolidone, and 1,3-dimethyl-2-imidazolidinone. The content of each of these water-soluble organic solvents is appropriate for avoiding degrading image characteristics and ejection reliability. Preferably, any of multivalent alcohols or alkylethers of multivalent alcohols is used. The content of the multivalent alcohol or the alkylether of the multivalent alcohol is desirably between 1 wt % and 30 wt %. The amount of purified water in the ink is preferably between 50 wt % and 90 wt %.

Examples of the die used as a coloring material include a direct die, an acid die, a basic die, a reactive die, a disperse die, and a construction die. The content of the die depends on the type of the liquid solvent component, characteristics required for the ink, the ejection amount of the print head, and the like. However, in general, the content of the die corresponds to 0.5 wt % to 15 wt %, preferably 1 wt % to 7 wt % of the total weight of the ink.

Furthermore, the present inventors have found that addition of thiodiglycol or urea (or a derivative thereof) to the ink allows the ink ejection characteristics of the print head and a clogging (fixation) prevention effect to be drastically improved. This is expected to be because the addition improves the solubility of the die in the ink. The content of the thiodiglycol or urea (or a derivative thereof) is preferably between 1 wt % and 30 wt %.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-159283, filed Jun. 18, 2008, which is hereby incorporated by reference herein in its entirety.

What is claimed is:

1. An ink jet printing apparatus for applying ink to a print medium to print an image on the print medium, the printing apparatus comprising:
a setting unit configured to set a drying condition under which a color of the image varies so that the color of the image becomes a target one having a color difference ΔE of at most 3 from a color with substantially no temporal variation;
a drying unit configured to dry the image according to the drying condition set by the setting unit; and
a discharging unit configured to discharge the print medium with the image dried by the drying unit, from the printing apparatus.

2. The ink jet printing apparatus according to claim 1, wherein the setting unit sets the drying condition according to a combination of the ink and the print medium used to print the image.

3. The ink jet printing apparatus according to claim 1, further comprising:
a test pattern printing unit configured to apply the ink to the print medium according to data on a test pattern allowing the drying condition to be set, to print the test pattern on the print medium; and
a condition determining unit configured to determine a drying condition under which a color of the test pattern varies so that the color of the test pattern becomes a target one having a color difference ΔE of at most 3 from a color with substantially no temporal variation,
wherein the setting unit sets the drying condition determined by the condition determining unit as the drying condition under which the color of the image varies.

4. The ink jet printing apparatus according to claim 1, further comprising:
a test pattern printing unit configured to apply the ink to the print medium according to data on a test pattern allowing the drying condition to be set, to print the test pattern on the print medium;
a measuring unit configured to measure a color of the test pattern printed by the test pattern printing unit; and
a condition determining unit configured to repeat the measurement of the test pattern by the measuring unit and the drying of the test pattern by the drying unit to determine a drying time in which the color of the test pattern varies so that the color of the test pattern becomes a target one having a color difference ΔE of at most 3 from a color with substantially no temporal variation,
wherein the setting unit sets the drying time determined by the condition determining unit as the drying condition.

5. The ink jet printing apparatus according to claim 1, wherein the color of the image with substantially no temporal variation is a color obtained by naturally drying the image for 24 hours.

6. An ink jet printing apparatus for applying ink to a print medium to print an image on the print medium, the printing apparatus comprising:
a drying unit configured to dry the image printed on the print medium;
a test pattern printing unit configured to apply the ink to the print medium according to data on a test pattern allowing a drying condition for the drying unit to be determined, to print the test pattern on the print medium;
a measuring unit configured to measure a color of the test pattern printed by the test pattern printing unit;
a condition determining unit configured to repeat the measurement of the test pattern by the measuring unit and the drying of the test pattern by the drying unit to determine a drying condition under which the color of the test pattern varies so that the color of the test pattern becomes a target one having a color difference ΔE of at most 3 from a color with substantially no temporal variation; and
a discharging unit configured to discharge the print medium with the image dried by the drying unit according to the drying condition determined by the condition determining unit, from the printing apparatus.

7. An ink jet printing apparatus for applying ink to a print medium to print an image on the print medium, the printing apparatus comprising:
a drying unit configured to dry the image printed on the print medium; and
a discharging unit configured to discharge the print medium with the image dried by the drying unit, from the printing apparatus,
wherein the drying unit dries the image so that a color of the image on the print medium not discharged by the discharging unit yet has become similar to a color with substantially no temporal variation, so as to prevent variation in the color of the image on the print medium discharged by the discharging unit from exceeding 3 in terms of color difference ΔE.

8. A drying condition determining method of determining a drying condition under which an image printed on a print medium by an ink jet printing apparatus is dried, the method comprising:
a step of determining the drying condition under which the image varies until a color of the image becomes a target one having a color difference ΔE of at most 3 from a color with substantially no temporal variation.

9. A drying condition determining method of determining a drying condition under which an image printed on a print medium by an ink jet printing apparatus is dried, the method comprising:
a printing step of applying ink to the print medium according to data on a test pattern allowing the drying condition to be determined, to print the test pattern on the print medium;
a measuring step of measuring a color of the test pattern printed on the print medium;
a drying step of drying the test pattern; and
a step of repeating the measuring step and the drying step to determine a drying condition under which the color of the test pattern varies so that the color of the test pattern becomes a target one having a color difference ΔE of at most 3 from a color with substantially no temporal variation.
